(19) United States
(12) Patent Application Publication
(10) Pub. No.: US 2013/0335424 A1
(43) Pub. Date: Dec. 19, 2013

(54) CHARACTER DISPLAY METHOD AND DEVICE

(71) Applicants: Xiaolei Wang, Beijing (CN); Lei Zhang, Beijing (CN); Li Ding, Beijing (CN)

(72) Inventors: Xiaolei Wang, Beijing (CN); Lei Zhang, Beijing (CN); Li Ding, Beijing (CN)

(73) Assignees: Peking University Founder Group Co. Ltd., Beijing (CN); Founder Information Industry Holdings Co., Ltd., Beijing (CN); Beijing Founder Apabi Technology Ltd., Beijing (CN)

(21) Appl. No.: 13/985,834

(22) PCT Filed: Dec. 20, 2012
(86) PCT No.: PCT/CN12/87035

§ 371 Date: Aug. 15, 2013

(30) Foreign Application Priority Data
Dec. 20, 2011 (CN) 201110430849.9

(51) Int. Cl. G06T 11/60

(52) U.S. Cl. CPC G06T 11/60
USPC 345/467

(57) ABSTRACT

A character display technique relating to computer information processing to improve the display of characters. Whether a thickening process on a glyph outline corresponding to a character to be displayed is needed is determined by calculating a mean grayscale value of pixels of a grayscale bitmap of the glyph outline. if thickening is to be performed, the thickening amount is determined on the basis of the mean grayscale value of pixels, and the thickened glyph outline is output for display, thereby minimizing problems of fading of the displayed color, fuzzy strokes and the like due to strokes that are too narrow, and thus improving the character display effect.

### FIELD OF THE INVENTION

The present invention relates to computer information processing, and more particularly, to a character display method and device.

### BACKGROUND OF THE INVENTION

With the rapid development of the digital publishing technology, more publishing companies are issuing publications, such as books and newspapers, in digital form. These digital publications are issued in an electronic document format for display on a screen of a device such as a computer, a handheld portable device, an electronic reader, or the like.

At the present time, publishing companies still need to consider both paper and electronic formats, and therefore, there are some situations wherein the content of an electronic document is suitable for paper publication, but not for display on a screen For example, conventional newspaper typesetting usually uses an outline font, such as TrueType font with narrow strokes in the letters or characters, and theses fonts with narrow strokes can provide a reader with good visual effect because a newspaper has high printing accuracy. However, when this kind of paper publication is directly used for digital publishing and displayed on a screen of the computer or the like, typical font anti-aliasing display techniques used today will cause undesired effects, such as fading of the displayed color, fuzzy strokes, and the like due to strokes that are too narrow, thus lowering the readability of the displayed document.

To solve these problems, a method has been proposed in which a determination of whether a glyph should be thickened for display is made on the basis of font metrics information. For example, stroke width of the character is determined on the basis of an attribute of the stem width of the font, and then, based on this stroke width, it is determined whether the glyph should be thickened for display. The disadvantage of this method is that the stem width and other font metrics information must be correctly written into a font file. However, in actual practice, when creating a font the, such font metrics information is usually not set in the font file.

As another proposal, the stem width is calculated from the stem edge of the glyph which, in turn, is detected on the basis of the rasterization result of the character. The calculated stem width determines whether the glyph should be thickened for display, But this method depends upon a complicated algorithm and generally is applicable only with fonts having horizontal and vertical strokes, but not with fonts having an irregular glyph.

### SUMMARY OF THE INVENTION

The present invention provides a character display method and device for improving the character display effect.

One embodiment of the character display method described herein includes: obtaining a glyph outline corresponding to at least one character from a font file; rasterizing each obtained glyph outline to obtain a grayscale bitmap using anti-aliased rasterization techniques and calculating a mean grayscale value of the pixels of each obtained grayscale bitmap; determining, on the basis of the mean grayscale value, whether the glyph outline corresponding to the character to be displayed should be thickened, and if so, determining the thickening amount on the basis of such mean grayscale value; performing a thickening process on the glyph outline on the basis of the thickening amount; and outputting data representing the thickened glyph outline for display.

One embodiment of the character display device described herein includes: a glyph outline unit for obtaining a glyph outline corresponding to at least one character from a font file; a grayscale unit for rasterizing each glyph outline to obtain a grayscale bitmap using anti-aliased rasterization techniques and for calculating a mean grayscale value of the pixels of each obtained grayscale bitmap; a thickening unit for determining, on the basis of the mean grayscale value, whether the glyph outline corresponding to the character to be displayed should be thickened and, if so, determining the thickening amount on the basis of such mean grayscale value of pixels, and thickening the glyph outline corresponding to the character to be displayed on the basis of the thickening amount; and an outputting unit for outputting data representing the thickened glyph outline for display.

Accordingly, in the present invention, it is determined whether a thickening process on a glyph outline corresponding to a character to be displayed should be performed by calculating the mean grayscale value of the pixels of a grayscale bitmap of the glyph outline in a font file. When the thickening process should be performed, a thickening amount is determined on the basis of the mean grayscale value of the pixels, and data representing the glyph outline corresponding to the character to be displayed is output for display after the thickening process has been performed on the basis of the thickening amount, thereby minimizing problems of fading of the displayed color, fuzzy strokes and the like due to strokes that are too narrow and thus improving the character display effect.

### OBJECTS OF THE INVENTION

Therefore, it is an object of this invention to electronically thicken the glyph of a character to be electronically displayed when it is determined the stroke of the character is too narrow.

Another object is to use the grayscale bitmap of the glyph to determine whether the glyph should be thickened.

A further object of this invention is to calculate the mean grayscale value of the pixels in the rasterized glyph to determine if the glyph should be thickened for display.

Various other objects and advantages of the invention will become apparent from the detailed discussion that follows; and the novel feature will be particularly pointed out in the appended claims.

### BRIEF DESCRIPTION OF THE DRAWINGS

FIG. 1 is a schematic flowchart of the operation performed by an embodiment of the present invention;

FIG. 2A is a schematic flowchart of the manner of displaying a character according to an embodiment of the present invention;

FIG. 2B is a schematic diagram of a glyph outline and the rasterization effect of the glyph outline according to an embodiment of the present invention;

FIG. 2C is a schematic diagram of the thickening effect of a glyph outline according to an embodiment of the present invention; and

FIG. 3 is a schematic diagram of an embodiment of a device in accordance with an embodiment of the present invention, such as a computer-implemented embodiment.

### DETAILED DESCRIPTION OF CERTAIN EMBODIMENTS

To improve the display of a character in accordance with one embodiment of the present invention, whether a thickening process on a glyph outline corresponding to a character to be displayed should be performed is determined by calculating a mean grayscale value of the pixels of a grayscale bitmap of the glyph outline in a font file. When the thickening process should be performed, the amount of thickening is determined on the basis of the calculated mean grayscale value, and the glyph outline is output for display after the thickening process has been performed thereon.

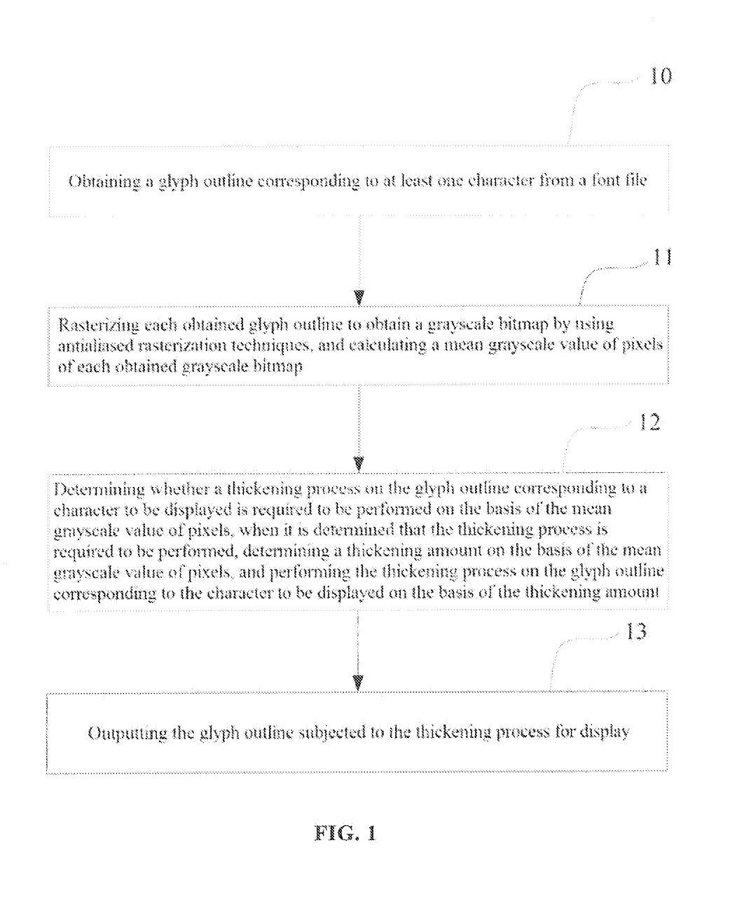

Referring to FIG. 1, one embodiment of the character display method in accordance with the present invention is schematically illustrated.

In step 10, a glyph outline corresponding to at least one character to be displayed is obtained from a previously stored font file, The character may be a preset common character or the like. The font, which is used to display the character, may be a vector font or the like.

Proceeding to step 11, each obtained glyph outline is rasterized to obtain a grayscale bitmap by using anti-aliased rasterization techniques, such as known techniques used by Microsoft Corp., Apple, Inc. and others, and a mean grayscale value of the pixels of each obtained grayscale bitmap is calculated.

Then, in step 12, it is determined whether a thickening process on the glyph outline obtained in step 10 should be performed on the basis of the mean grayscale value calculated in step 11. When it is determined that the thickening process should be performed, the amount of thickening is determined on the basis of the mean grayscale value calculated in step 11 and the thickening process is performed on the glyph outline corresponding to the character to be displayed. In step 13, the glyph outline that had been subjected to the thickening process is output for display.

In step 10 the glyph outline of a character is obtained from the font file; and the size of the font may be enlarged, if desired The enlarged display font size is N times the current display font size, where N is greater than 1, preferably, N is 2 or more. The display font size (referred to as the current display font size) is a function of the display device used to display the characters.

Preferably, if the current display font size is not in pixel units, the current display font size may be converted to a display font size in pixel units on the basis of pixels per inch (PPI) of a typical display device before obtaining the glyph outline of the character with the enlarged display font size from the font file. One example of a font size conversion method is.

DisplayFontSize_{after}_{_{—}}_{conversion}=(DisplayFONTSize_{before}_{_{—}}_{conversion}/InchVal)*PPI

wherein, DisplayFontSize_{after}_{_{—}}_{conversion} is the display font size in pixel units after conversion, DisplayFontSize_{before}_{_{—}}_{conversion} is the current display font size before conversion, InchVal is the size of the display font in units corresponding to one point, and PPI is the PPI of the typical display device. As one example, inchVal may be 72.

In step 11, the calculation of the mean grayscale value of pixels of each obtained grayscale bitmap, for example, may be implemented as follows:

When one grayscale bitmap of the character is obtained after rasterization, the mean value of the grayscale values of those pixels whose grayscale value is not 0 is calculated, and the calculated mean value serves as the mean grayscale value of pixels.

As another example, a plurality of grayscale bitmaps are obtained after rasterization for a plurality of characters, respectively, and for each of the grayscale bitmaps, a first mean value of the grayscale values of those pixels in each character whose grayscale value is not 0 is calculated respectively, and then a second mean value is calculated from the first mean values obtained for the plurality of grayscale bitmaps. The calculated second mean value serves as the mean grayscale value of pixels.

In step 12, the determination of whether the thickening process on the glyph outline should be performed may be implemented as follows:

If the mean grayscale value of pixels calculated in step 11 is larger than a predetermined grayscale threshold value, thickening need not be performed. However, if the mean grayscale value is less than this threshold, the glyph outline corresponding to the character to be displayed should be thickened, The predetermined grayscale threshold value is more than 0. Preferably, the predetermined grayscale threshold value may be ⅔.

Alternatively, thickening of the glyph outline may be determined on the basis of whether the mean grayscale value of pixels calculated in step 11 is within a predetermined grayscale range. If so, the thickening of the glyph outline need not be performed. However, if the mean grayscale value is outside that range, the thickening process on the glyph outline should be performed. Preferably, the predetermined grayscale range may be a range from ⅔ to 1.

In step 12, the thickening amount is determined on the basis of the mean grayscale value of pixels. As one example, the difference between 1 and the mean grayscale value of pixels is calculated, and this calculated difference is used as the thickening amount.

Alternatively, thickening may be determined in accordance with a preset correspondence between mean grayscale values of pixels calculated in step 11 and thickening amounts.

It will be appreciated, the method of determining the thickening amount on the basis of the mean grayscale value of pixels is not limited to those described above, and any other method capable of determining the thickening amount efficiently on the basis of the mean grayscale value of pixels is contemplated by the present invention.

In the present method, a glyph outline in a vector font is a path represented by a series of straight lines and Bezier curves. The thickening amount represents a distance that the glyph outline expands outwards, and may be in pixel units.

Referring now to Figure A, a more detailed flowchart of the character display method used in the present invention now will be described below. It will be appreciated, this flowchart represents the steps performed by, for example, a suitably programmed microprocessor that executes instructions stored on a non-transitory computer-readable medium to carry out the character display techniques described herein.

In step 201, a font file of the font of the character to be displayed is loaded. Styles of the font to be displayed include TrueType font, OpenType font and other known vector fonts.

In step 202, one or more reference glyph outlines are obtained from the loaded font file. For example, glyph outlines of one or more typical English letters and/or Chinese characters in the font fife are obtained as the reference glyph outlines, As one example, the glyph outlines of the English letter “PR” and the Chinese character “ [symbol] ” in the font file are used as the reference glyph outlines.

Here, the glyph outline in a vector font is a path represented by a series of straight lines and Bezier curves. In one embodiment, the font size used by the reference glyph outline is twice the font size intended to be displayed (the current display font size). The current display font size is in pixel units. if the unit of the current display font size is in point size, such as Post Script point, the current display font size is converted to a display font size in pixel units on the basis of the PPI parameter of the display device on which the characters are to be displayed.

Proceeding to step 203, the obtained reference glyph outline(s) is rasterized to obtain grayscale bitmap(s) by using typical anti-aliased rasterization techniques, and a mean grayscale value of pixels corresponding to the grayscale bitmap(s) is calculated. If one grayscale bitmap is obtained, the mean value of the grayscale values of those pixels in the bitmap whose grayscale value is not 0 serves as the mean grayscale value of pixels. If a plurality of grayscale bitmaps for a plurality of respective characters is obtained, for each of the grayscale bitmaps, a first mean value of the grayscale values of those pixels in the bitmap for each character whose grayscale value is not 0 is calculated; and then a second mean value is calculated from the first mean values of the plural bitmaps. This second mean value serves as the mean grayscale value of pixels.

The mean grayscale value of pixels is a value between 0 and 1.

The process advances to inquiry 204, which determines if the mean grayscale value of pixels is larger than or equal to ⅔. If the mean grayscale value is equal to or greater than the threshold ⅔, the thickening process on the glyph outline corresponding to the character to be displayed need not be performed, and the process advances to step 209. However, if the mean grayscale value is less than the threshold ⅔, the process advances to step 205.

In step 205, the thickening amount is calculated on the basis of the mean grayscale value of pixels. For example, if the mean grayscale value of pixels is the value G, then the thickening amount by which the glyph should be thickened equals 1-G. The thickening amount is in pixel units, representing the distance that the glyph outline expands outwards.

The process then advances to step 206, in which the glyph outline of the character to be displayed with the current display font size is obtained from the font file that had been loaded in step 201.

Then, in step 207, the thickening amount calculated in step 205 is used as the basis for the thickening process on the glyph outline obtained in step 206. The thickening process is performed on the current display font size.

In step 208, the thickened glyph outline is output to a display device for display, and the flow ends.

Returning to step 209, the glyph outline of the character to be displayed with the current display font size is obtained from the font file that had been loaded in step 201.

In step 210, the glyph outline of the character to be displayed with the current display font size (and no thickening) is output to a display device for display, and the flow ends.

With the character display method disclosed in the present embodiment, when displaying characters in an electronic document, it is determined whether a thickening display is needed and the thickening amount is calculated from the mean grayscale value of pixels of a grayscale bitmap of a glyph outline in a font file The glyph outline whose stroke is too narrow is thickened and then displayed. This avoids displaying strokes that are too narrow, in which the color tends to fade and the strokes tend to be fuzzy, which causes readability to become poorer.

It can be seen, the present embodiment does not require pre-recording metrics information in a font file. Thus the present invention is applicable to virtually all vector fonts, and is not limited only to horizontal and vertical strokes of the font. The present embodiment thus has wide applicability.

Now, one example is used to describe the advantages of the character display method of the present invention. In this example, the font style that is used is Anal, the current display font size is 4.5 (e.g. 4.5 point), the PPI of the current display device is 96, and the current display font size in pixel units is calculated to be 4.5÷72×96=6.

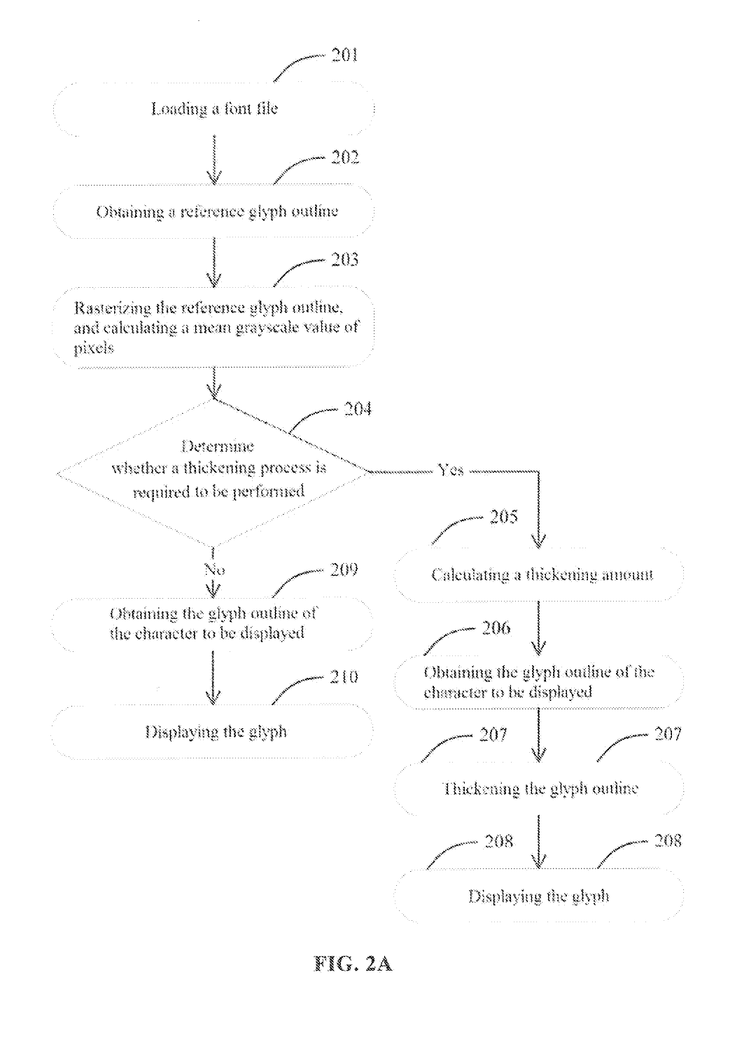

In step 201 of FIG. 2A, the font file of the Anal font style is loaded.

In step 202, the glyph outline of the character “R” having the typical font size 12 is obtained as the reference glyph outline, as shown in the left of FIG. 28

In step 203, the reference glyph outline is rastenized to obtain an 8-bit grayscale bitmap, and a partial enlarged effect of the rasterization result (3×2 pixels) is shown in the right of FIG. 28, wherein the grayscale value of each pixel ranges from 0 to 1. Inasmuch as there are 256 grayscale values (0, 1, 2, . . . 255), the bitmap shown in FIG. 26 represents the normalized grayscale values (i.e. each grayscale value divided by 255). Here, the mean grayscale value of the pixels of the bitmap for the entire character (not just the portion of the character shown in FIG. 26) is calculated to be 0.6, which is less than ⅔. This means that the thickening process on the glyph outline corresponding to the character to be displayed should be performed (in step 204), and the thickening amount is calculated (step 205) to be 1-0.6=0.4.

In step 206, the glyph outline of the character to be displayed with the current display font size is obtained. Recall, the character to be displayed is “R” and the glyph outline is thickened (step 207) by 0.4 pixels. The result is shown in FIG. 2C.

In step 208, the thickened glyph outline corresponding to the character to be displayed is displayed.

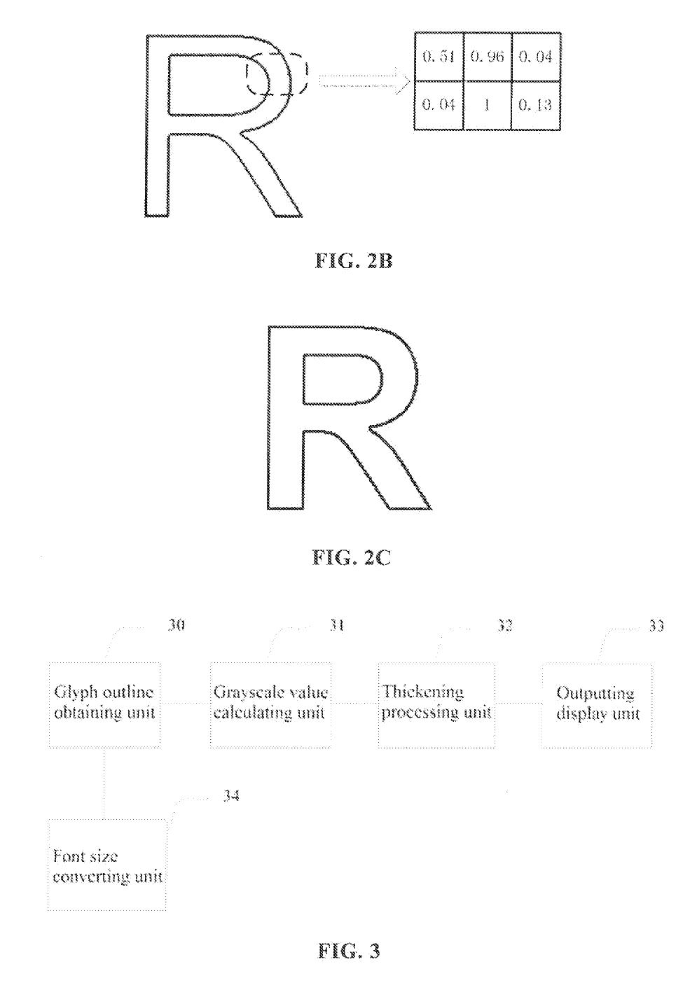

Referring now to FIG. 3, a character display device is illustrated. In the embodiment of the present invention, the device is implemented by a suitably programmed microprocessor that executes instructions stored on a computer readable record medium (not shown). This device includes: a glyph outline obtaining unit 30 for obtaining a glyph outline corresponding to at least one character from a font file; a grayscale value calculating unit 31 for rasterizing each obtained glyph outline to obtain a grayscale bitmap by using anti-aliased rasterization techniques, and from which a mean grayscale value of pixels of each obtained grayscale bitmap is calculated; and a thickening processing unit 32 for determining whether a thickening process on the glyph outline corresponding to the character to be displayed should be performed on the basis of the mean grayscale value of pixels, and for performing the thickening. The thickening processing unit 32 determines the thickening amount on the basis of the mean grayscale value of pixels, and performs the thickening process on the glyph outline corresponding to the character to be displayed on the basis of that thickening amount. An output unit 33 outputs the glyph outline subjected to the thickening process for display.

The glyph outline obtaining unit 30 is used to obtain from the font file a glyph outline of at least one character. The glyph outline may have an enlarged display font size. The enlarged display font size is N times a current display font size, where N is more than 1. As an example, N is 2.

The device illustrated in FIG. 3 also includes a font size converting unit 34. When the current display font size is not in pixel units, before obtaining the glyph outline of the character with the enlarged display font size from the font file, the font size converting unit 34 is used to convert the current display font size to a display font size in pixel units on the basis of PFI of the display device used therewith:.

The grayscale value calculating unit 31 is used to calculate the mean value of grayscale values of those pixels in the grayscale bitmap whose grayscale value is not 0 when one grayscale bitmap is obtained, and this mean value serves as the mean grayscale value of pixels. For the embodiment wherein plural grayscale bitmaps are obtained for plural respective characters, the grayscale value calculating unit 31 is used to calculate for each such bitmap for each character a first mean value of grayscale values of the pixels in that character whose grayscale value is not 0, and to calculate a second mean value from first mean values, and the second mean value serves as the mean grayscale value of the pixels.

The thickening processing unit 32 is used to determine whether the mean grayscale value of pixels is larger than a predetermined grayscale threshold value. If the mean grayscale value of pixels is larger than the predetermined grayscale threshold value, the thickening process on the glyph outline corresponding to the character to be displayed need not be performed. However, if the mean grayscale value of pixels is less than the grayscale threshold value, the thickening process on the glyph outline is performed. As an example, the predetermined grayscale threshold value is ⅔.

The output unit 33 is used to calculate a difference between 1 and the mean grayscale value of pixels. This difference is used as the thickening amount. Alternatively, the output unit 33 determines the thickening amount on the basis of a prestored correspondence between mean grayscale values of the pixels and thickening amounts.

In summary, a glyph outline corresponding to at least one character is obtained from a font file, each obtained glyph outline is rasterized to obtain a grayscale bitmap by using anti-aliased rasterization techniques, and a mean grayscale value of the pixels in each obtained grayscale bitmap is calculated. Whether or not a thickening process on the glyph outline corresponding to a character to be displayed should be performed is determined on the basis of the mean grayscale value of pixels. When it is determined that the thickening process should be performed, the thickening amount is determined on the basis of the mean grayscale value of pixels. The glyph outline subjected to the thickening process is output for display. As a result, problems of fading of the displayed color, fuzzy strokes and the like due to too narrow strokes are avoided, thus improving the character display effect.

The present invention has been described with reference to the methods, devices (systems), and the flowchart and/or block diagram of computer-implemented instructions according to the embodiments of the present invention. It should be understood that such instructions may be provided to a general purpose computer, a dedicated computer, an embedded processor, or other processor of a programmable data processing device to produce a machine, such that the instructions which are performed by a computer or other processor of programmable data processing device produce a device used to implement the functions designated by one or more steps in the flowchart and/or one or more blocks in the block diagram.

These instructions may be stored in a non-transitory computer readable memory which can instruct a computer or other programmable data processing device to function in a particular manner, such that the instructions stored in the computer readable memory produce a product including an instruction device. The instruction device implements the functions designated by one or more steps in the flowchart and/or one or more blocks in the block diagram.

While the preferred embodiments of the present invention have been described, once a person skilled in the art appreciates the basic inventive concept herein, additional variations and modifications can be made to these embodiments. Therefore, the following claims intend to be interpreted to include preferred embodiments and all variations and modifications within the scope of the present invention.

Obviously, various modifications and variations can be made by the person skilled in the art without departing from the spirit and scope of the present invention. As such, if these modifications and variations of the present invention come within the scope of the claims and their equivalents, it is intended that the present invention cover such modifications and variations.

1. A character display method, including:
obtaining a glyph outline corresponding to at least one character from a font file;
rasterizing by anti-aliased rasterization, each obtained glyph outline to obtain a grayscale bitmap;
calculating a mean grayscale value of pixels of the grayscale bitmap;
determining, on the basis of the mean grayscale value of pixels, whether a thickening process on said glyph outline is to be performed
determining, if the thickening process is to be performed a thickening amount on the basis of the mean grayscale value of pixels,
performing the thickening process on said glyph outline on the basis of the thickening amount; and
outputting the glyph outline, subjected to the thickening process, for display.

2. The method of claim I, wherein said glyph outline of at least one character is obtained with an enlarged display font size, and wherein the enlarged display font size is N times the display font size of the character to be displayed, where N is greater than 1.

3. The method of claim 2, wherein N is 2.

4. The method of claim 2, wherein if the display font size of the character to be displayed is not in pixel units, said display font size of the character to be displayed is converted to a display font size in pixel units on the basis of pixels per inch displayed by a display device on which the character is to be displayed before said glyph outline with the enlarged display font size is obtained from the font file.

5. The method of claim 1, wherein the mean grayscale value of pixels of the grayscale bitmap is obtained by: (a) when obtaining one grayscale bitmap, calculating a mean value of grayscale values of the pixels whose grayscale value is not 0 in the grayscale bitmap, wherein said calculated mean value is the mean grayscale value of pixels; or (b) when obtaining a plurality of grayscale bitmaps, calculating for each of the grayscale bitmaps, a first mean value of grayscale values of the pixels whose grayscale value is not 0 in the respective grayscale bitmap, and calculating a second mean value from said first mean values, wherein said calculated second mean value is the mean grayscale value of pixels.

6. The method of claim 1, wherein whether the thickening process on said glyph outline is to be performed is determined by whether the mean grayscale value of pixels is larger than a predetermined grayscale threshold value and, if so, it is determined that the thickening process on the glyph outline corresponding to the character to be displayed need not be performed but if the mean grayscale value of pixels is less than said predetermined grayscale threshold value, it is determined that the thickening process is to be performed.

7. The method of claim 6, wherein the predetermined grayscale threshold value is ⅔.

8. The method of claim 1, wherein the thickening amount is determined on the basis of the mean grayscale value of pixels by calculating a difference between 1 and the mean grayscale value of pixels, wherein said calculated difference is used as the thickening amount.

9. The method of claim 1, wherein the thickening amount is in accordance with a preset correspondence between mean grayscale values of pixels and thickening amounts.

10. A character display device implemented by a programmed processor, including:
a glyph outline obtaining unit for obtaining a glyph outline corresponding to at least one character from a font file;
a grayscale value calculating unit for rasterizing by anti-aliased rasterization each obtained glyph outline to obtain a grayscale bitmap and for calculating a mean grayscale value of pixels of the grayscale bitmap;
a thickening processing unit for determining, on the basis of the mean grayscale value of pixels, whether a thickening process on said glyph outline is to be performed, determining, if the thickening process is to be performed, a thickening amount on the basis of the mean grayscale value of pixels, and performing the thickening process on said glyph outline on the basis of the thickening amount; and
an output unit for outputting the glyph outline subjected to the thickening process for display.

11. The device of claim 10, wherein said glyph outline obtaining unit obtains a glyph outline of at least one character from the font file with an enlarged display font size, wherein the enlarged display font size is N times the display font size of the character to be displayed, where N is more than 1.

12. A n -transitory computer-readable medium on which is stored instructions which, when read by a processor, implements a character display method comprising:
obtaining a glyph outline corresponding to at least one character from a font file;
rasterizing by anti-aliased rasterization, each obtained glyph outline to obtain a grayscale bitmap;
calculating a mean grayscale value of pixels of the grayscale bitmap;
determining, on the basis of the mean grayscale value of pixels, whether a thickening process on said glyph outline is to be performed
determining, if the thickening process is to be performed, a thickening amount on the basis of the mean grayscale value of pixels, performing tie thickening process on said glyph outline on the basis of the thickening amount; and
outputting the glyph outline, subjected to the thickening process, for display.
